(19) United States
(12) Patent Application Publication
(10) Pub. No.: US 2018/0319622 A1
(43) Pub. Date: Nov. 8, 2018

(54) ELEVATOR SYSTEM AND METHOD FOR CONTROLLING AN ELEVATOR SYSTEM

(71) Applicants: Peter HERKEL, Berlin (DE); Otis Elevator Company, Farmington, CT (US)

(72) Inventors: Peter Herkel, Berlin (DE); Dirk Tegtmeier, Berlin (DE)

(21) Appl. No.: 15/773,661

(22) PCT Filed: Oct. 27, 2016
(86) PCT No.: PCT/EP2016/075907

§ 371 Date: May 4, 2018

(30) Foreign Application Priority Data
Nov. 5, 2015 (EP) PCT/EP2015/075812

(51) Int. Cl. B66B 1/28; B66B 1/34; B66B 5/00; B66B 9/00; B66B 5/02

(52) U.S. Cl. CPC B66B 1/28; B66B 1/3492; B66B 5/02; B66B 9/00; B66B 5/0018

(57) ABSTRACT

An elevator system (2) comprises: a hoistway (14) extending between a plurality of landing zones (6, 8, 9); at least one elevator car (12) configured for moving along the hoistway (14); at least one positional sensor (24, 26, 63, 83, 93) arranged at a defined position within the hoistway (14); a speed and/or acceleration sensor (25), which is configured for determining current speed and/or acceleration information of the at least one elevator car (12) within the hoistway (14); and an elevator controller (28), which is configured for: A) calculating current positional information of the at least one elevator car (12) within the hoistway (14) from the speed and/or acceleration information; B) checking the validity of the speed and/or acceleration information; C) in case the speed and/or acceleration information is determined as being valid: operating the elevator system (2) based on the calculated positional information; D) in case the speed and/or acceleration information is determined as not being valid: D1) starting a timer; D2) controlling the at least one elevator car (12) to run by the at least one positional sensor (24, 26, 63, 83, 93) for re-calibrating the positional information of the at least one elevator car (12); and D3) stopping any operation of the elevator system (2), in case the at least one elevator car (12) has not run by the at least one positional sensor (24, 26, 63, 83, 93) within a predetermined period of time from starting the timer.

The present invention relates to an elevator system and a method for controlling an elevator system.

Elevator systems typically include at least one elevator car moving along a hoistway extending between a plurality of landings. Usually, movement of the car is controlled by a shaft encoder delivering a signal indicative of the number of rotations of the drive machine. In addition, a plurality of positional sensors are provided within the hoistway for detecting the current position of the elevator car in the hoistway when the elevator car passes one of the sensors, and thereby correcting the signal from the shaft encoder. In order to allow for sufficiently precise positioning of the elevator car at each of the landings, usually a high density of positional sensors is necessary in the vicinity of each of the landings. A typical installation includes four sensors per landing area and four to eight sensors at the upper and lower terminals of the hoistway, respectively.

The installation and maintenance of such a large number of positional sensors is expensive and laborious. It therefore would be beneficial to be able to reduce the number of positional sensors provided within the hoistway without degrading the operational safety the elevator system.

According to an embodiment of the invention an elevator system comprises:
a hoistway extending between a plurality of landing zones;
at least one elevator car, which is configured for moving along the hoistway;
at least one positional sensor, which is arranged at a defined position within the hoistway;
a speed and/or acceleration sensor, which is configured for determining current speed and/or acceleration information of the at least one elevator car within the hoistway; and
a controller, which is configured for:
A) calculating current positional information of the at least one elevator car within the hoistway from the speed and/or acceleration information received from the speed and/or acceleration sensor;
B) checking the validity of the speed and/or acceleration information;
C) in case the speed and/or acceleration information is determined as being valid: operating the elevator system based on the calculated positional information;
D) in case the speed and/or acceleration information is determined as not being valid:
   D1) starting a timer;
   D2) controlling the at least one elevator car to run by the at least one positional sensor for re-calibrating the positional information of the at least one elevator car; and
   D3) stopping any operation of the elevator system, in case the at least one elevator car has not run by the at least one positional sensor within a predetermined period of time from starting the timer.

According to an embodiment of the invention, a method of controlling an elevator system according to an embodiment of the invention comprises the steps of:
a) determining the current speed and/or acceleration of the at least one elevator car within the hoistway and providing speed and/or acceleration information;
b) calculating current positional information of the at least one elevator car within the hoistway from the provided speed and/or acceleration information;
c) checking the validity of the speed and/or acceleration information;
d) in case the speed and/or acceleration information is determined as being valid: operating the elevator system based on the calculated positional information; and
e) in case the speed and/or acceleration information is determined as not being valid:
   e1) starting a timer;
   e2) controlling the at least one elevator car to run by the at least one positional sensor for re-calibrating the positional information of the at least one elevator car; and
   e3) stopping any operation of the elevator system, in case the at least one elevator car has not run by the at least one positional sensor within a predetermined period of time from starting the timer.

The term “operation of the elevator system”, as it is used here, is to be understood as the normal “automatic” operation, in which the elevator system is operated by an electronic controller based on passengers' requests for transportation. Said requests, for example, may be input via control panels provided within the elevator car and/or at the different floors/landings served by the elevator system. When said “automatic” operation based on the passengers' requests has been stopped, as it has been described before under items D3) and e3), respectively, the elevator system still may be operated “manually” or “on-demand” by an operator/mechanic for re-calibrating the positional information in order to allow for returning to normal (“automatic”) operation.

The term “speed and/or acceleration sensor”, as it is used here, is to be understood as encompassing a speed sensor providing speed information, an acceleration sensor providing acceleration information, a combined speed and acceleration sensor providing speed and acceleration information, and a combination of a speed sensor, which provides speed information, and an acceleration sensor, which provides acceleration information.

Since the movement of the at least one elevator car is controlled based on the speed and/or acceleration information provided by the speed and/or acceleration sensor, an elevator system and a method for controlling such an elevator system according to exemplary embodiments described herein allow to considerably reduce the number of positional sensors needed within the hoistway. By integrating speed information over time and/or by integrating acceleration information twice over time the position of the elevator car may be calculated with sufficient precision for controlling the movement of the elevator car in the vicinity of a landing without additional car position sensors in the hoistway. A high level of operational safety is maintained by regularly checking the validity of the speed and/or acceleration information provided by the speed and/or acceleration sensor and re-calibrating the positional information, if necessary. For re-calibrating the positional information only a reduced number of positional sensors needs to be arranged along the hoistway.

Exemplary embodiments of the invention will be described in the following with respect to the enclosed figures.

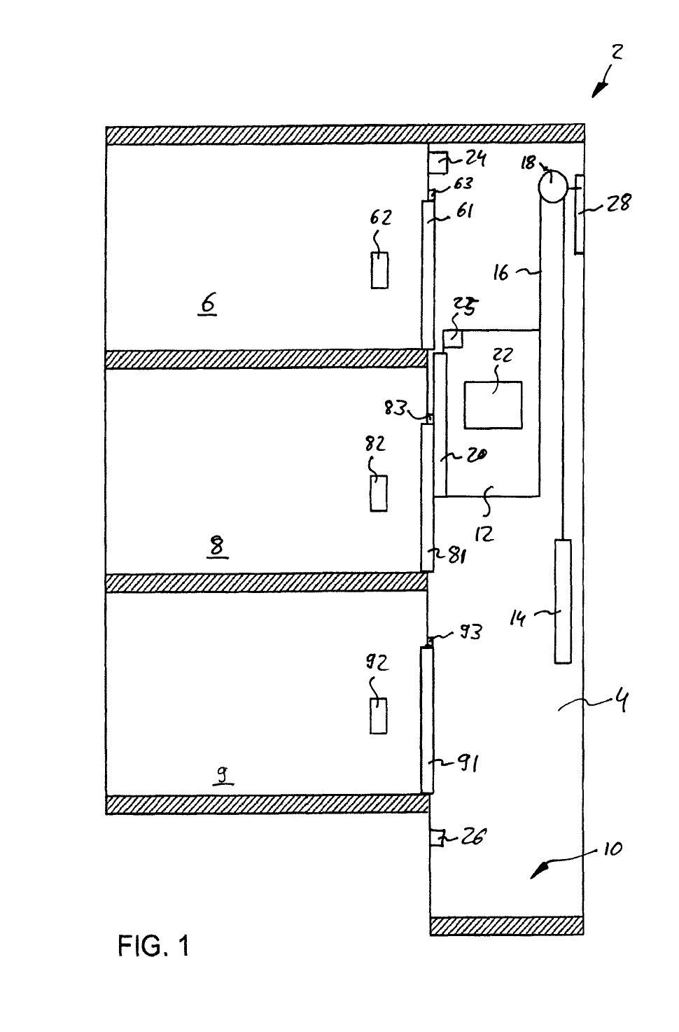

FIG. 1 shows a schematic view of an elevator system according to an exemplary embodiment of the invention.

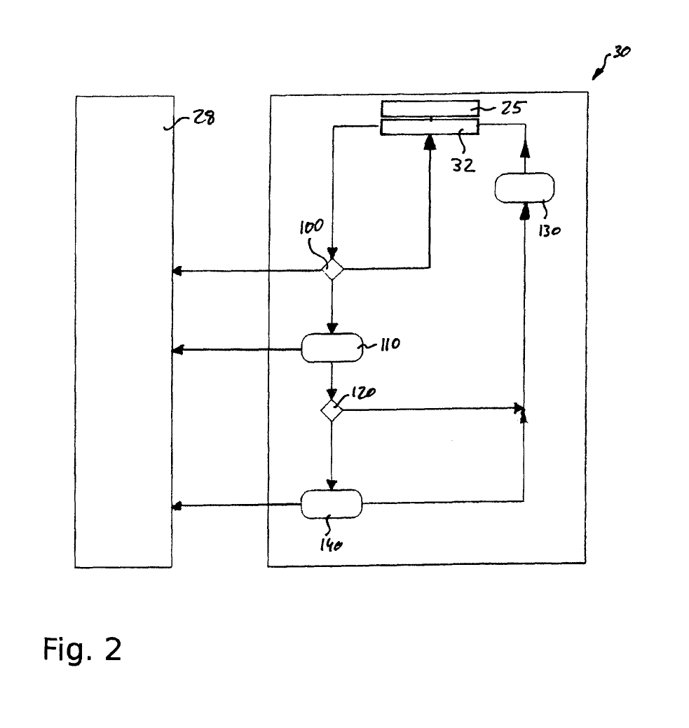

FIG. 2 shows a flow chart of controlling the operation of the elevator system according to an exemplary embodiment of the invention, and

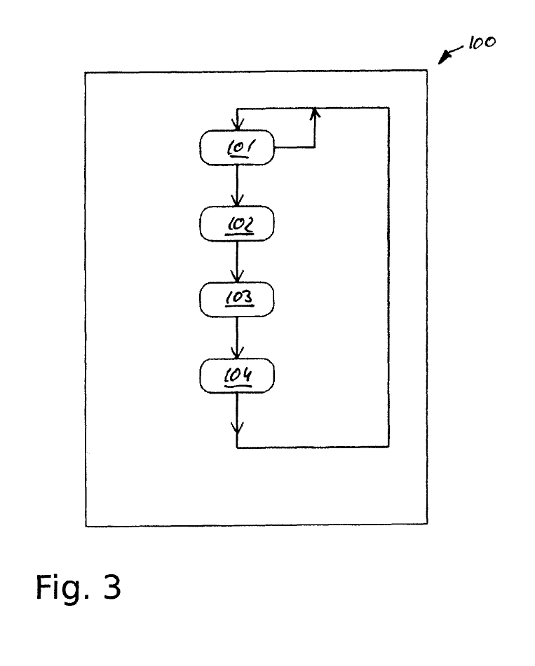

FIG. 3 shows a flow chart schematically illustrating the validation of speed and/or acceleration data provided by the speed and/or acceleration sensor according to an exemplary embodiment of the invention.

FIG. 1 shows a schematic view of an elevator system 2 according to an exemplary embodiment of the invention.

The elevator system 2 comprises a hoistway 4 vertically extending between a plurality of floors/landings 6, 8, 9.

A landing door 61, 81, 91 providing access to the hoistway 4 and a control panel 62, 82, 92 are arranged at each of the landings 6, 8, 9, respectively.

An elevator car 12 and a corresponding counterweight 14 are movably suspended by means of a tension member 16 within the hoistway 4, allowing the elevator car 12 and the counterweight 14 to move vertically along the hoistway 4 in opposite directions.

The elevator car 12 is provided with at least one elevator car door 20 and an elevator car control panel 22.

The tension member 16 may be rope, a belt or a combination of ropes/belts. The tension member 16 extends over a drive sheave 18, which is provided in an upper area of the hoistway 4.

The drive sheave 18 is rotatably driven by a motor, which is not shown in FIG. 1, in order to move the elevator car 12 between the landings 6, 8, 9 along the hoistway 4.

FIG. 1 depicts a simple 1:1 suspension of the elevator car 12. The skilled person, however, will easily understand that different suspensions, such as 2:1, 4:1, 8:1 etc. and similar suspensions, which may include, or may not include, a counterweight 14, may be used in elevator systems 2 according to exemplary embodiments of the invention, as well.

The elevator car 12 is driven by a drive machine comprising the motor and the traction sheave, thus forming a traction drive. The motor (not shown) driving the drive sheave 18 is controlled by an elevator control 28 based on input provided via the control panels 62, 82, 92, 22 according to the passengers' requests. Other drive machines than a traction drive are conceivable as well, e.g. linear drives or hydraulic drives.

The elevator car 12 is provided with a speed and/or acceleration sensor 25, which is configured for providing information about the current speed and/or acceleration of the elevator car 12 while moving along the hoistway. Said information may be transferred to the elevator control 28 by means of a cable (not shown) extending along the hoistway 4, or by means of wireless data transmission.

The elevator control 28 is configured for controlling the movement of the elevator car 12 along the hoistway 4 by driving the drive sheave 18 based on the speed and/or acceleration information provided by the speed and/or acceleration sensor 25. In order to allow the elevator control 28 to position the elevator car 12 exactly at the desired landing 6, 8, 9, i.e. in a position in which the elevator car door 20 is aligned with one of the landing doors 61, 81, 91, the speed and/or acceleration information provided by the speed and/or acceleration sensor 25 is converted into positional information by integrating the speed information over time and/or by integrating the acceleration information twice over time.

For ensuring safe operation of the elevator system 2, the elevator control 28 regularly checks the validity of the speed and/or acceleration information provided by the speed and/or acceleration sensor 25. In case the elevator control 28 determines the speed and/or acceleration information as not being valid, i.e. as degraded or even invalid, the elevator control 28 re-calibrates the positional information.

In order to allow re-calibrating the positional information, at least one positional sensor 24, 26, 63, 83, 93 is arranged within the hoistway 4. Each of the positional sensors 24, 26, 63, 83, 93 is configured for detecting a well defined portion of the elevator car 12, e.g. the bottom or the top of the elevator car 12 or the position of the speed and/or acceleration sensor 25, which is arranged at the elevator car 12, when it is positioned at the same height as the respective positional sensor 24, 26, 63, 83, 93. In consequence, the current position of the elevator car 12 within the hoistway 4 is detected when it passes one of the positional sensors 24, 26, 63, 83, 93.

In the embodiment shown in FIG. 1, a positional sensor 63, 83, 93 is positioned at each landing, in particular at the top of each landing door 61, 81, 91, respectively. Additional positional sensors 24, 26 are arranged at the top of the hoistway 4 and within a pit 10, which is formed at the bottom of the hoistway 4, respectively.

The configuration illustrated in FIG. 1, however, is only exemplary. In particular, it is not necessary to provide a positional sensor 63, 83, 93 at each landing 6, 8, 9. The positional sensor 63, 83, 93 assigned to a landing may be provided at a position different from the top of the respective landing door 61, 81, 91, as well. In principle, it would be sufficient to provide a single positional sensor at a predefined position in the hoistway 4.

FIG. 2 schematically illustrates a flow chart 30 of a method of controlling the elevator system 2 based on the speed and/or acceleration information provided by the speed and/or acceleration sensor 25.

A position calculator 32, which may be provided in hardware or software, may integrate speed information provided by the speed and/or acceleration sensor 25 over time for providing positional information. Additionally or alternatively, positional information may be obtained by integrating acceleration information provided by the speed and/or acceleration sensor 25 twice over time.

In a following step 100 it is determined whether the speed and/or acceleration information provided by the speed and/or acceleration sensor 25 is safe and valid.

The details of said determination will be explained in detail further below with reference to FIG. 3.

In case the speed and/or acceleration information is determined as being safe and valid, the positional information calculated by the position calculator 32 is transmitted to the elevator control 28 for controlling the elevator system 2, i.e. for moving the elevator car 12 to the next desired position within the hoistway 4, e.g. a landing 6, 8, 9 requested by a passenger.

In case, however, the speed and/or acceleration information is considered as not being safe and valid, but as degraded, a timer is started in step 110. Said timer is configured for counting the period of time the elevator system 2 is operated based on degraded positional information. Additionally, the elevator control 28 is instructed to drive the elevator car 12 to a position for re-calibrating the positional information. The position for re-calibrating the positional information is selected in such a manner that the elevator car 12 has to pass at least one of the positional sensors 63, 83, 93, 24, 26 provided within the hoistway 4 for re-calibrating the positional information.

In case such a position is reached before the count of the timer has reached a predetermined upper limit (step 120), the positional information is re-calibrated (step 130) based on the well-known position of the respective positional sensor 24, 26, 63, 83, 93 within the hoistway 4. Afterwards, normal operation of the elevator system 2 resumes with the current position of the elevator car 12 being calculated starting from the re-calibrated starting position by integrating the speed and/or acceleration information provided by the speed and/or acceleration sensor 25.

In case, however, the count of the timer reaches a predetermined upper limit before the elevator car 12 has reached a position for re-calibrating the positional information (e.g. by positioning the elevator car 12 next to at least one of the positional sensors 24, 26, 63, 83, 93), the speed and/or acceleration information is considered as being invalid. In consequence, any further operation of the elevator system 2 is considered unsafe and therefore any further operation of the elevator system 2 is stopped immediately (step 140) until the positional information has been re-calibrated. The positional information may be re-calibrated in particular by the intervention of an operator/mechanic causing the elevator car 12 to be positioned next to at least one of the positional sensors 24, 26, 63, 83, 93.

In this situation, the elevator system 2 may be operated only manually, in particular without any passengers being present within the elevator car 12. In order to bring the elevator system 2 back into an operational state, the elevator car 12 needs to be moved manually to a position for re-calibrating the positional information. When the elevator car 12 passes one of the positional sensors 24, 26, 63, 83, 93 for re-calibrating the positional information (step 130) normal operation starting from said re-calibrated position may be returned.

This method allows for safe operation of the elevator system 2 using only a small number of positional sensors 24, 26, 63, 83, 93 arranged within the hoistway 4.

FIG. 3 depicts a further flow chart illustrating a method of validating the speed and/or acceleration information according to an exemplary embodiment of the invention, as it is implemented as step 100 in the method of elevator control illustrated in FIG. 2.

In a first step 101 it is determined whether new speed and/or acceleration information has been received from the speed and/or acceleration sensor 25.

In a second step 102 it is determined whether the new speed and/or acceleration information has been received within a predetermined period of time. The speed and/or acceleration sensor 25 is configured to periodically provide updated speed and/or acceleration information, and in consequence, a malfunction is detected in case updated speed and/or acceleration information is not received within a predetermined period of time.

In case new speed and/or acceleration information has been received within the predetermined period of time, it is checked whether the protocol of the received data is correct (step 103). Said data protocol in particular may comprise one or more check sums allowing to detect transmission errors within the provided speed and/or acceleration information. In this case, checking whether the protocol of the received data is correct, in particular comprises checking the check sum(s) provided by the protocol.

If the protocol of the received data has been determined as being correct, it is determined in a next step 104 whether the received speed and/or acceleration information is plausible. Checking whether the received speed and/or acceleration information is plausible may include checking whether the received speed and/or acceleration information is comprised within a predetermined range in order to detect implausibly large speed and/or acceleration values. The range of allowable speed and/or acceleration values in particular may depend on previously received speed and/or acceleration information. For example, as the maximum acceleration of the elevator car 12 is limited, it is not plausible that the received speed is at a maximum value shortly after the elevator car 12 has been stationary. It is also not plausible that the elevator car 12 is completely stopped from maximum speed in a very short period of time.

Alternatively or additionally, a gradient of the received speed information representing the acceleration of the elevator car 12 may be calculated, and it may be checked whether said gradient/acceleration is comprised within a predetermined range as well.

In case speed and acceleration information is provided by the speed and/or acceleration sensor 25, first positional information obtained from the speed information may be compared to second positional information obtained from acceleration. The obtained information may be considered as being valid and correct if the difference between these differently calculated first and second positional informations does not exceed a predetermined threshold.

In case all these requirements are fulfilled, the received speed and/or acceleration information is considered as being valid and correct. In consequence, the positional information calculated from said speed and/or acceleration information is considered as being valid and correct as well, and the operation of the elevator system 2 is continued based on the positional information calculated from the received speed and/or acceleration information.

In case, however, at least one requirement is not fulfilled, the speed and/or acceleration information is considered as invalid and the control of the elevator system 2 continues on the basis of the “degraded” speed and/or acceleration information, as it has been discussed before with respect to FIG. 2.

In case a very severe defect of the received speed and/or acceleration information is detected, e.g. if at least one of the received speed and/or acceleration information and the calculated acceleration of the elevator car 12 is well outside a predetermined range, the method of controlling the elevator system 2 may switch to the situation of invalid positional information (FIG. 2: step 140) immediately, i.e. without waiting for the expiration of a predetermined time limit. This avoids any further movement of the elevator car 12 based on such degraded positional information in case a very severe defect of the received speed and/or acceleration information, which does not allow for a safe operation of the elevator system, has been detected. This enhances the safety of operating the elevator system 2 even further.

### FURTHER EMBODIMENTS

A number of optional features are set out in the following. These features may be realized in particular embodiments, alone or in combination with any of the other features.

In the exemplary embodiment shown in FIG. 1 a positional sensor is provided at each landing, in particular at the top of each landing door. Thus, the elevator car will reach a positional sensor at each landing and thus normal operation of the elevator system may resume within a short period of time after the speed and/or acceleration information has been determined as being degraded. As a result, the risk that the operation of the elevator system needs to be stopped since thespeed and/or acceleration or positional information has been determined as being invalid (FIG. 2: step 140) is low.

However, in such a configuration, still a relatively large number of positional sensors is necessary.

Thus, in embodiments, a positional sensor may be provided not at every landing, but only at one or more but not all of the landings. In such a configuration the number of positional sensors may be reduced considerably. However, the elevator car might need to travel more distance before reaching a positional sensor after the speed and/or acceleration information has been declared as being degraded.

However, it is beneficial to provide positional sensors at least at the top and the bottom, e.g. in the pit, of the hoistway in order to allow for re-calibrating the positional information of the elevator car in case the positional information has been totally lost and in particular for preventing the elevator car from hitting the ceiling or the bottom of the hoistway, respectively.

Checking the validity of the speed and/or acceleration information may include checking whether new speed and/or acceleration information has been received within a predetermined period of time. This allows to detect a failure of the speed and/or acceleration sensor quickly and it allows to deactivate the speed and/or acceleration sensor, such which has the effect that the speed sensor and/or acceleration does not deliver updated speed and/or acceleration information anymore.

Checking the validity of the speed and/or acceleration information may include checking whether the format/protocol of the received speed and/or acceleration information is correct in order to reliably detect errors of the delivered speed and/or acceleration information which may result from a malfunction of the speed and/or acceleration sensor or from an erroneous data transmission.

Checking the validity of the speed and/or acceleration information may include checking at least one checksum included in the protocol. Such checksums allow to reliably detect errors within the delivered speed and/or acceleration information which may result from a malfunction of the sensor or from an erroneous data transmission.

Checking the validity of the speed and/or acceleration information may include checking whether the received speed and/or acceleration information is plausible. This allows to detect errors which result from an erroneous speed and/or acceleration detection, which are not detected by checking the format/protocol of the received speed and/or acceleration information as the transmitted data is formally correct.

Checking whether the received speed and/or acceleration information is plausible may include determining whether the received speed and/or acceleration information is above a predetermined lower limit and below a predetermined upper limit. This allows to detect implausible data, i.e. implausible high or low speed and/or acceleration information data.

At least one of “above a predetermined lower limit” and “below a predetermined upper limit” may be a function of the current position of the elevator car. This allows to shift the range of plausible speed and/or acceleration data according to the current operational status of the elevator system, which, in consequence, enhances the quality of the error detection.

Checking whether the received speed and/or acceleration information is plausible may include calculating a gradient of the received speed and/or acceleration information and determining whether the gradient of the received speed and/or acceleration information is above a predetermined lower gradient limit and below a predetermined upper gradient limit. This allows to detect implausibly fast or slow changing speed and/or acceleration data which in particular corresponds to physically impossible accelerations/decelerations of the elevator car.

At least one of “above a predetermined lower gradient limit” and “below a predetermined upper gradient limit” may be a function of the current speed of the elevator car. This allows to shift the range of plausible acceleration data according to the current operational status of the elevator system, which, in consequence, enhances the quality of the error detection.

As a result, exemplary embodiments of the invention allow for a safe operation of an elevator system employing a reduced number of positional sensors within the hoistway reducing the costs and labor for installing and maintaining the elevator system.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system
4 hoistway
6, 8, 9 floors/landings
10 pit
12 elevator car
14 counterweight
16 tension member
18 drive sheave
20 elevator car door
22 elevator car control panel
24 positional sensor
25 speed and/or acceleration sensor
26 positional sensor
28 elevator control
30 flow chart of a method of controlling the elevator system
32 position calculator
61, 81, 91 landing door
63, 83, 93 positional sensor
100 determination whether the positional information
101 determination whether new speed and/or acceleration information has been received from the speed and/or acceleration sensor
102 determination whether the new speed and/or acceleration information has been received within a predetermined period of time
103 checking whether the protocol of the received data is correct
104 checking whether the received speed and/or acceleration information is plausible
110 starting the timer
120 reaching the position of a positional sensor
130 recalibration of the positional information
140 stopping operation of the elevator system

1. A method of controlling an elevator system (2), wherein the elevator system (2) comprises:
a hoistway (14);
at least one elevator car (12) configured for moving along the hoistway (14);
at least one positional sensor (24, 26, 63, 83, 93) arranged at a defined position within the hoistway (14); and
a speed and/or acceleration sensor (25) configured for determining the current speed and/or acceleration of the at least one elevator car (12) within the hoistway (14);
and wherein the method comprises the steps of:
a) determining the current speed and/or acceleration of the at least one elevator car (12) within the hoistway (14) and providing speed and/or acceleration information;
b) calculating current positional information of the at least one elevator car (12) within the hoistway (14) from the provided speed and/or acceleration information;
c) checking (100) the validity of the speed and/or acceleration information;
d) in case the speed and/or acceleration information is determined as being valid: operating the elevator system (2) based on the calculated positional information;
e) in case the speed and/or acceleration information is determined as not being valid:
e1) starting a timer;
e2) controlling the at least one elevator car (2) to run by the at least one positional sensor (24, 26, 63, 83, 93) for re-calibrating the positional information of the at least one elevator car (2); and
e3) stopping any operation of the elevator system (2), in case the at least one elevator car (2) has not run by the at least one positional sensor (24, 26, 63, 83, 93) within a predetermined period of time from starting the timer.

2. The method of claim 1, wherein checking the validity of the speed and/or acceleration information includes the step (102) of checking whether new speed and/or acceleration information has been received within a predetermined period of time.

3. The method of claim 1, wherein checking the validity of the speed and/or acceleration information includes the step (103) of checking whether the format/protocol of the received speed and/or acceleration information is correct.

4. The method of claim 3, wherein checking the validity of the speed and/or acceleration information includes checking checksums included in the protocol.

5. The method of claim 1, wherein checking the validity of the speed and/or acceleration information includes the step (104) of checking whether the received speed and/or acceleration information is plausible.

6. The method of claim 5, wherein the step (104) of checking whether the received speed and/or acceleration information is plausible includes determining whether the received speed and/or acceleration information is above a predetermined lower limit and below a predetermined upper limit.

7. The method of claim 6, wherein at least one of the predetermined lower limit and the predetermined upper limit is a function of the current position of the elevator car (12).

8. The method of claim 4, wherein the step (104) of checking whether the received speed and/or acceleration information is plausible includes calculating a gradient of the received speed and/or acceleration information and determining whether the gradient of the received speed and/or acceleration information is above a predetermined lower gradient limit and below a predetermined upper gradient limit.

9. The method of claim 8, wherein at least one of the predetermined lower gradient limit and the predetermined upper gradient limit is a function of the current speed and/or acceleration of the elevator car (12).

10. An elevator system (2) comprising:
a hoistway (14) extending between a plurality of landing zones (6, 8, 9);
at least one elevator car (12) configured for moving along the hoistway (14);
at least one positional sensor (24, 26, 63, 83, 93) arranged at a defined position within the hoistway (14);
a speed and/or acceleration sensor (25), which is configured for determining current speed and/or acceleration information of the at least one elevator car (12) within the hoistway (14); and
an elevator controller (28), which is configured for:
A) calculating current positional information of the at least one elevator car (2) within the hoistway (14) from the speed and/or acceleration information;
B) checking the validity of the speed and/or acceleration information provided by the speed and/or acceleration sensor (25);
C) in case the speed and/or acceleration information is determined as being valid: operating the elevator system (2) based on the calculated positional information;
D) in case the speed and/or acceleration information is determined as not being valid:
D1) starting a timer;
D2) controlling the at least one elevator car (12) to run by the at least one positional sensor (24, 26, 63, 83, 93) for re-calibrating the positional information of the at least one elevator car (12); and
D3) stopping any operation of the elevator system (2), in case the at least one elevator car (12) has not run by the at least one positional sensor (24, 26, 63, 83, 93) within a predetermined period of time from starting the timer.

11. The elevator system (2) of claim 10, wherein the at least one positional sensor (63, 83, 93) is arranged at one of the landing zones (6, 8, 9).

12. The elevator system (2) of claim 10, wherein a positional sensor (63, 83, 93) is arranged at each of a plurality of the landing zones (6, 8, 9), respectively.

13. The elevator system (2) of claim 12, wherein a positional sensor (63, 83, 93) is arranged at each of the landing zones (6, 8, 9).

14. The elevator system (2) of claim 10, wherein a positional sensor (24, 26) is arranged at the bottom and/or at the top of the hoistway (14).
